(19) United States
(12) Patent Application Publication
(10) Pub. No.: US 2021/0199950 A1
(43) Pub. Date: Jul. 1, 2021

(54) LASER INTEGRATED SWITCHING DEVICE

(71) Applicant: GREAT COMPUTER CORP., New Taipei City (TW)

(72) Inventors: Liang SHIH, New Taipei City (TW); Yu-Sheng WU, New Taipei City (TW); Heng-Kuan LIN, New Taipei City (TW); Chia-Liang LU, New Taipei City (TW)

(21) Appl. No.: 16/852,928

(22) Filed: Apr. 20, 2020

(30) Foreign Application Priority Data
Dec. 31, 2019 (TW) 108148687

(51) Int. Cl. G02B 26/08; B23K 26/36; B23K 26/082

(52) U.S. Cl. CPC G02B 26/0816; B23K 26/082; B23K 26/36

(57) ABSTRACT

A laser integrated switching device for mounting on a laser cutting machine is disclosed, wherein it comprises a laser tube, a X/Y deflection laser outputting module, a triaxial deflection laser outputting module, a first optical path, a second optical path, and an optical path switcher; wherein the first optical path is disposed with both ends thereof connecting to the laser tube and the X/Y deflection laser outputting module, the second optical path is disposed with both ends thereof connecting to the laser tube and the triaxial deflection laser outputting module, and the optical path switcher is disposed between the first and second optical paths, thereby before the optical path switcher switches the laser beams to the first optical path or the second optical path, the laser tube alternately outputs laser beams to the X/Y deflection laser outputting module or the triaxial deflection laser outputting module.

### FIELD OF THE INVENTION

The present invention relates to a laser integrated switching device with a simple structure and cost-reduced integration of a X/Y deflection laser outputting module and a triaxial deflection laser outputting module on the same machine, particularly for an existing laser cutting machine merely having one of the abovementioned laser outputting modules to upgrade.

### BACKGROUND OF THE INVENTION

A laser machining apparatus basically directs the emitted laser beams and focuses the beams on an article to be cut. The beams focused thereon are absorbed by the material of the article, resulting in evaporation of the material under this condition to from a depression or dent on the surface of the article, thereby attaining the object of engraving and cutting.

Currently, the procedure of a conventional laser cutting machine is to position a workpiece before cutting, then a laser tube irradiates the laser beam into a X/Y deflection laser outputting module or a triaxial deflection laser outputting module, and the cutting procedure is completed under the control of a computer. Therefore, the current laser cutting machines are divided into two product lines for consumers to choose and purchase based on the cutting model of a X/Y deflection laser outputting module or a triaxial deflection laser outputting module as need.

### SUMMARY OF THE INVENTION

However, according to the existing design of the laser cutting machine, users have to proceed on two different machines if both the cutting patterns mentioned above are desired. As such, except for the raising machine cost, the transferring process could detract from the efficiency and the precision due to the position realignment. Therefore, there is a need in the art for an improvement that is able to effectively operate both the X/Y and triaxial deflection laser outputting module in a single operation.

A main object of the present invention is to provide a laser integrated switching device with a simple structure and cost-reduced integration of a X/Y deflection laser outputting module and a triaxial deflection laser outputting module on the same machine.

To achieve the abovementioned object, the laser integrated switching device of the present is used for mounting on a laser cutting machine, and comprises a laser tube, a X/Y deflection laser outputting module, a triaxial deflection laser outputting module, a first optical path, a second optical path, and an optical path switcher. The first optical path is disposed with both ends thereof connecting to the laser tube and the X/Y deflection laser outputting module, so as to allow the emitted laser beams progress to the X/Y deflection laser outputting module along the first optical path. The second optical path is disposed with both ends thereof connecting to the laser tube and the triaxial deflection laser outputting module on which the emitted laser beams progress to the triaxial deflection laser outputting module along the second optical path. The optical path switcher is disposed between the first and second optical paths, wherein before the optical path switcher switches the laser beams to the first optical path or the second optical path, the laser tube alternately outputs laser beams to the X/Y deflection laser outputting module or the triaxial deflection laser outputting module.

In implementation, the first optical path sequentially consists of a first reflection mirror set, a first beam expander, and a second reflection mirror set, wherein both ends of the first optical path connect to the laser tube and the X/Y deflection laser outputting module to allow the laser beams emitted from the laser tube and received by the first reflection mirror set to progress to the X/Y deflection laser outputting module via the first beam expander and the second reflection mirror set; and the second optical path sequentially consists of a third reflection mirror set, a second beam expander, and a fourth reflection mirror set, wherein both ends of the second optical path connect to the laser tube and the triaxial deflection laser outputting module to allow the laser beams to progress to the triaxial deflection laser outputting module via the third reflection mirror set, the second beam expander, and the fourth reflection mirror set, wherein when the optical path switcher switches to the second optical path, the emitted laser beams are switched to progress along the second optical path, and when the optical path switcher is switched away from the second optical path, the emitted laser beams progress along the first optical path.

In implementation, the first optical path sequentially consists of a fifth reflection mirror set, a sixth reflection mirror set, a third beam expander, and a seventh reflection mirror set, wherein both ends of the first optical path connect to the laser tube and the X/Y deflection laser outputting module to allow the laser beams emitted from the laser tube and received by the fifth reflection mirror set to progress to the X/Y deflection laser outputting module via the sixth reflection mirror set, the third beam expander, and the seventh reflection mirror set; and the second optical path sequentially consists of an eighth reflection mirror set and a fourth beam expander, wherein both ends of the second optical path connect to the laser tube and the triaxial deflection laser outputting module to allow the laser beams to progress to the triaxial deflection laser outputting module via the eighth reflection mirror set and the fourth beam expander, wherein when the optical path switcher switches to the first optical path, the emitted laser beams are switched to progress along the first optical path, and when the optical path switcher is switched away from the first optical path, the emitted laser beams progress along the second optical path.

Other objects, advantages and novel features of the present invention will become more apparent from the following detailed description when taken in conjunction with the accompanying drawings.

### BRIEF DESCRIPTION OF THE DRAWINGS

FIG. 1 is a schematic configuration view showing an embodiment of the present invention.

FIG. 2 is a schematic configuration view showing an embodiment of the present invention applied in the case where a triaxial deflection laser outputting module is to be added/upgraded into an existing X/Y deflection laser outputting module.

FIG. 3 is a schematic configuration view showing an embodiment of the present invention applied in the case where a X/Y deflection laser outputting module is to be added/upgraded into an existing triaxial deflection laser outputting module.

### DETAILED DESCRIPTION

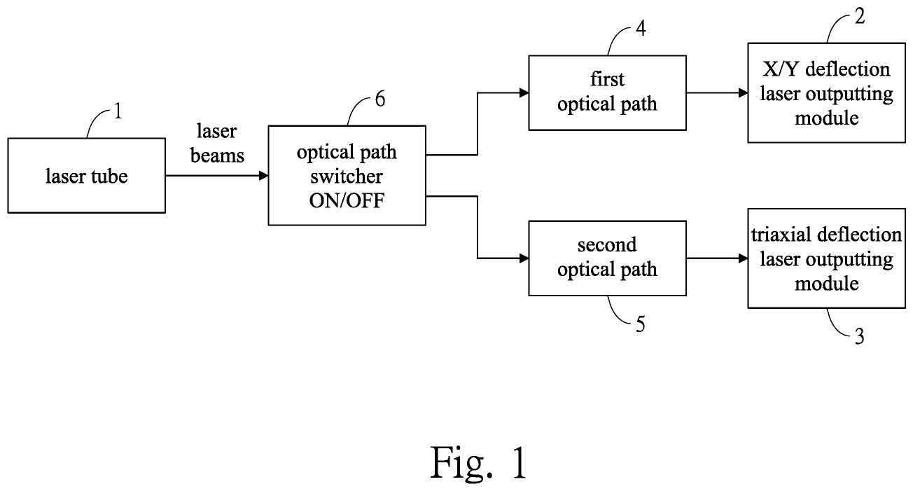

Referring to FIG. 1, a laser integrated switching device of a preferred embodiment of the present invention is disclosed. The laser integrated switching device is used for mounting on a laser cutting machine, and mainly consists of a laser tube 1, a X/Y deflection laser outputting module 2, a triaxial deflection laser outputting module 3, a first optical path 4, a second optical path 5, and an optical path switcher 6.

The first optical path 4 is disposed with both ends thereof connecting to the laser tube 1 and the X/Y deflection laser outputting module 2, so as to allow the emitted laser beams progress to the X/Y deflection laser outputting module 2 along the first optical path 4. The second optical path 5 is disposed with both ends thereof connecting to the laser tube 1 and the triaxial deflection laser outputting module 3 on which the emitted laser beams progress to the triaxial deflection laser outputting module 3 along the second optical path 5. The optical path switcher 6 is disposed between the first optical path 4 and second optical path 5, wherein before the optical path switcher 6 switches the laser beams to the first optical path 4 or the second optical path 5, the laser tube 1 can alternately output laser beams to the X/Y deflection laser outputting module 2 or the triaxial deflection laser outputting module 3.

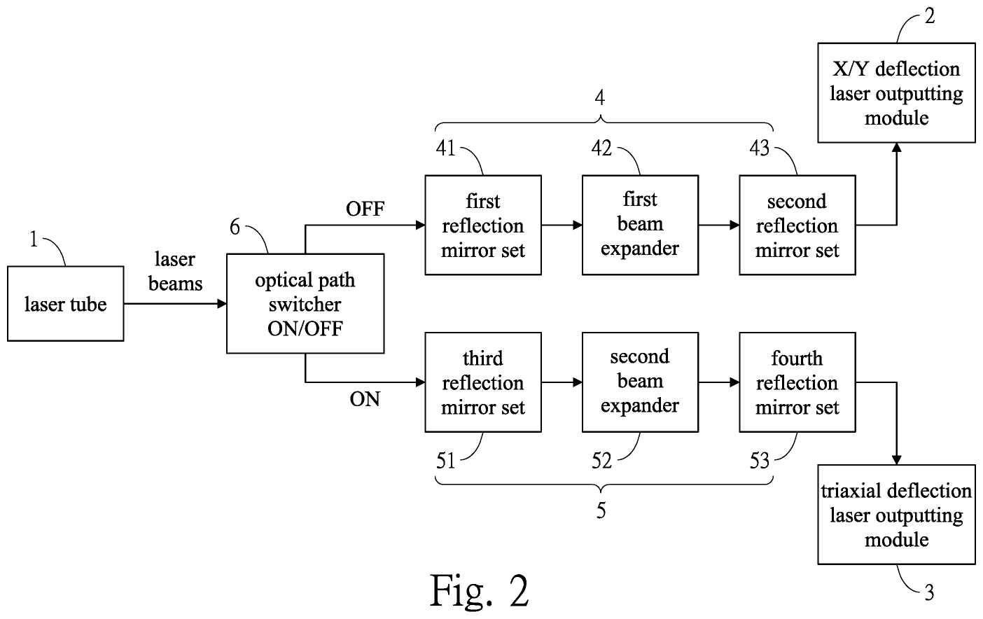

Accordingly, as shown in FIG. 2, when the present invention is applied in the case where a triaxial deflection laser outputting module 3 is to be added/upgraded into an existing X/Y deflection laser outputting module 2, the first optical path 4 sequentially consists of a first reflection mirror set 41, a first beam expander 42, and a second reflection mirror set 43, so as to allow the laser beams emitted from the laser tube 1 and received by the first reflection mirror set 41 progress to the X/Y deflection laser outputting module 2 via the first beam expander 42 and the second reflection mirror set 43. Further, the second optical path 5 sequentially consists of a third reflection mirror set 51, a second beam expander 52, and a fourth reflection mirror set 53, so as to allow the laser beams progress to the triaxial deflection laser outputting module 3 via the third reflection mirror set 42, the second beam expander 52 and the fourth reflection mirror set 53. Therefore, when the optical path switcher 6 switches to the second optical path 5 (i.e., a status “ON”), the emitted laser beams can be switched to progress along the second optical path 5, and when the optical path switcher 6 is switched away from the second optical path 5 (i.e., a status “OFF”), the emitted laser beams progress along the first optical path 4.

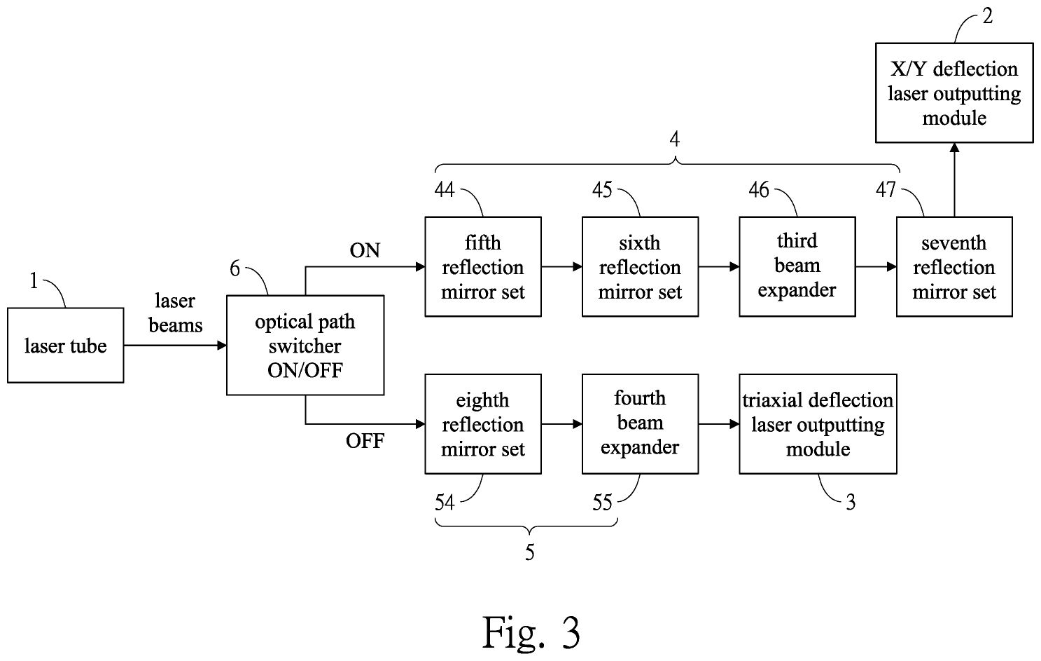

On the other hand, as shown in FIG. 3, when the present invention is applied in the case where a X/Y deflection laser outputting module 2 is to be added/upgraded into an existing triaxial deflection laser outputting module 3, the first optical path 4 sequentially consists of a fifth reflection mirror set 44, a sixth reflection mirror set 45, a third beam expander 46 and a seventh reflection mirror set 47, so as to allow the laser beams emitted from the laser tube 1 and received by the fifth reflection mirror set 44 to progress to the X/Y deflection laser outputting module 2 via the sixth reflection mirror set 45, the third beam expander 46, and the seventh reflection mirror set 47. Further, the second optical path 5 sequentially consists of an eighth reflection mirror set 54 and a fourth beam expander 55, so as to allow the laser beams to progress to the triaxial deflection laser outputting module 3 via the eighth reflection mirror set 54 and the fourth beam expander 55. Therefore, when the optical path switcher 6 switches to the first optical path 4, the emitted laser beams are switched to progress along the first optical path 4 (i.e., a status “ON”), and when the optical path switcher 6 is switched away from the first optical path 4 (i.e., a status “OFF”), the emitted laser beams progress along the second optical path 5.

Moreover, the X/Y deflection laser outputting module 2 of the present invention can cooperate with a creasing device, so as to proceed to crease a workpiece after switching to the creasing device during operation.

As stated in the above disclosed, the present invention allows users as needed to upgrade the existing laser cutting machine for both cutting patterns mentioned above, thereby equipping the same laser cutting machine with a triaxial deflection laser outputting module and a X/Y deflection laser outputting module without purchasing a new cutting machine. Therefore, the production cost is decreased, and the efficiency and precision are also enhanced by bypassing the position alignment in operation.

The exemplary embodiments have been illustrated; however, the laser integrated switching device for mounting on a laser cutting machine according to the present invention is not limited thereto. According to modifications or combinations of the embodiments, various types of laser integrated switching device can be realized having the scope of the present invention and thus without departing from the technical spirit of the present invention.

As disclosed above, the present invention indeed achieves the objectives of the present invention by providing a laser integrated switching device for mounting on a laser cutting machine. The present invention has significant values in terms of industrial applications, and a patent application is thus filed in accordance with the law.

1. A laser integrated switching device for mounting on a laser cutting machine, comprising:
a laser tube for emitting laser beams;
a X/Y deflection laser outputting module;
a triaxial deflection laser outputting module;
a first optical path with both ends thereof connecting to the laser tube and the X/Y deflection laser outputting module on which the laser beams progress to the X/Y deflection laser outputting module along the first optical path;
a second optical path with both ends thereof connecting to the laser tube and the triaxial deflection laser outputting module on which the laser beams progress to the triaxial deflection laser outputting module along the second optical path;
an optical path switcher disposed between the first and second optical paths, wherein before the optical path switcher switches the laser beams to the first optical path or the second optical path, the laser tube alternately outputs laser beams to the X/Y deflection laser outputting module or the triaxial deflection laser outputting module.

2. The laser integrated switching device of claim 1, wherein
the first optical path sequentially consists of a first reflection mirror set, a first beam expander, and a second reflection mirror set, wherein both ends of the first optical path connect to the laser tube and the X/Y deflection laser outputting module to allow the laser beams emitted from the laser tube and received by the first reflection mirror set to progress to the X/Y deflection laser outputting module via the first beam expander and the second reflection mirror set; and
the second optical path sequentially consists of a third reflection mirror set, a second beam expander, and a fourth reflection mirror set, wherein both ends of the second optical path connect to the laser tube and the triaxial deflection laser outputting module to allow the laser beams to progress to the triaxial deflection laser outputting module via the third reflection mirror set, the second beam expander, and the fourth reflection mirror set, wherein when the optical path switcher switches to the second optical path, the laser beams are switched to progress along the second optical path, and when the optical path switcher is switched away from the second optical path, the laser beams progress along the first optical path.

3. The laser integrated switching device of claim 1, wherein
the first optical path sequentially consists of a fifth reflection mirror set, a sixth reflection mirror set, a third beam expander, and a seventh reflection mirror set, wherein both ends of the first optical path connect to the laser tube and the X/Y deflection laser outputting module to allow the laser beams emitted from the laser tube and received by the fifth reflection mirror set to progress to the X/Y deflection laser outputting module via the sixth reflection mirror set, the third beam expander, and the seventh reflection mirror set; and
the second optical path sequentially consists of an eighth reflection mirror set and a fourth beam expander, wherein both ends of the second optical path connect to the laser tube and the triaxial deflection laser outputting module to allow the laser beams to progress to the triaxial deflection laser outputting module via the eighth reflection mirror set and the fourth beam expander, wherein when the optical path switcher switches to the first optical path, the laser beams are switched to progress along the first optical path, and when the optical path switcher is switched away from the first optical path, the laser beams progress along the second optical path.

4. The laser integrated switching device of claim 1, wherein the X/Y deflection laser outputting module connects to a creasing device, so as to proceed to crease after switching to the creasing device during operation.
